(19) United States
(12) Patent Application Publication
(10) Pub. No.: US 2004/0213115 A1
(43) Pub. Date: Oct. 28, 2004

(54) Optical head, disc recording/reproducing apparatus, and objective lens drive method

(76) Inventors: Hideki Nakata, Souraku-gun (JP); Hironori Tomita, Ikoma-shi (JP); Toru Tanaka, Kobe-shi (JP); Koji Okamura, Kawanishi-shi (JP); Katutoshi Sumida, Katano-shi (JP)

Correspondence Address: Merchant & Gould, PO Box 2903, Minneapolis, MN, 55402-0903, US

(21) Appl. No.: 10/477,032

(22) PCT Filed: May 9, 2002
(86) PCT No.: PCT/JP02/04513

(30) Foreign Application Priority Data
May 11, 2001 (JP) 2001-141213

(51) Int. Cl. G11B 7/08

(52) U.S. Cl. 369/53.23; 369/44.14; 369/47.44; 369/53.28

(57) ABSTRACT

An optical head includes an integrated unit (9) having a light-receiving portion for converting reflected light from a disc-shape recording medium (13) into an electric signal and a light source, an objective lens (11), a tracking coil (18a) for driving the objective lens (11) in a radial direction of the disc-shape recording medium (13), a focusing coil (18b) for driving the objective lens (11) in a focus direction of the disc-shape recording medium (13), a signal generation portion (102) for generating a focus error signal and a tracking error signal from the electric signal converted at the light-receiving portion, and a control portion (101) for controlling the tracking coil (18a) and the focusing coil (18b) on the basis of the focus error signal and the tracking error signal. The control portion calculates a defocus amount corresponding to a shift amount of the objective lens in the radial direction due to the tracking coil and applies an offset signal generated on the basis of the defocus amount to the focus error signal.

### TECHNICAL FIELD

The present invention relates to an optical head for projecting a light spot on a disc-shape recording medium and optically recording/reproducing information, a disk recording/reproducing apparatus and a method of driving an objective lens.

### BACKGROUND ART

Recently, various recording/reproducing disks such as DVD, MD, CD and CR-R have been developed. In association with this, optical heads and disk recording/reproducing apparatuses for playing the disks have been diversified, and efforts have been made for high performance, high quality and added values.

Particularly, demands for portable disk recording/reproducing apparatuses using magneto-optical recording media represented by recordable magneto-optical disks have tended to increase, and thus downsizing, reduction in thickness, high performance and cost reduction have been required further.

Related techniques have been reported for optical heads and disk recording/reproducing apparatuses used for magnet-optical recording media. A conventional optical head for a magneto-optical recording medium will be described below by referring to FIGS. 12-16. FIGS. 12-16 show examples using magneto-optical disks for the magneto-optical recording media.

First, a schematic configuration of an optical head will be described by referring to FIGS. 12 and 13. FIG. 12 is an exploded perspective view showing a configuration of a conventional optical head. FIG. 13 is an exploded perspective view showing a schematic configuration of a feeder of a conventional optical head.

As shown in FIG. 12, an optical head is configured by arranging, on an optical base 19, a reflection mirror 10, an integrated unit 9, an objective lens drive apparatus 14, a flexible circuit 35, a cover 33 to which a nut plate is attached, and a heat-radiation plate 4. The integrated unit 9 is connected to the flexible circuit 35 via a terminal (not shown), and the connection is carried out before disposing these elements on the optical base 19.

The objective lens drive apparatus 14 includes an objective lens holder 12, a base 15, a suspension 16, a magnetic circuit 17, a focusing coil 18a, and a tracking coil 18b. The objective lens drive apparatus 14 drives the objective lens 11 in a focus direction and in a radial direction of the magneto-optical recording medium (magneto-optical disk) by applying current to the focusing coil 18a and the tracking coil 18b.

Specifically, the objective lens 11 can be driven in the focus direction by applying current to the focusing coil 18a. The objective lens 11 can be driven in the radial direction by applying current to the tracking coil 18b. The objective lens 11 is fixed to the objective lens holder 12.

A drive circuit for applying current to the focusing coil 18a and to the tracking coil 18b, and also a control circuit for controlling the thus applied current are disposed on a substrate (not shown) provided independently from the objective lens drive apparatus 14, the integrated unit 9 or the like. The drive circuit and the control circuit are connected to the focusing coil 18a and the tracking coil 18b via the flexible circuit 35.

Furthermore, as shown in FIG. 13, a feeder is attached to the optical head 43 shown in FIG. 12. Main components of the feeder include a feed screw 36, a countershaft 37, a feed motor 38, gears 39a, 39b, and a bearing 41. The feeder is attached to a mechanical base 42. In FIG. 13, the mechanical base 42 is illustrated schematically.

The optical head 43 is attached to the mechanical base 42 by fitting the feed screw 36 through a nut plate 40. Therefore, when the feed motor 38 rotates, the feed screw 36 rotates through the gears 39a and 39b, and thus the optical head 43 is shifted by the feed screw 36 in the radial direction of the optical magneto-recording medium (not shown) indicated with an arrow The shift amount of the optical head 43 is determined on terms of the gear ratio of the gear 39a to the gear 39b and a reduction ratio calculated on the basis of the gear ratio and a pitch of the feed screw 36.

As mentioned above, the shift of the optical head with respect to the magneto-optical recording medium is carried out by the objective lens drive apparatus 14 and the feeder. FIGS. 14A-14C are used to describe an operation of the optical head shown in FIGS. 12 and 13, directed from the inner circumference to the periphery (movement in the radial direction) of the magneto-optical recording medium.

FIG. 14A is a graph showing a waveform of a drive current in a tracking coil that drives an objective lens in a radial direction. FIG. 14B is a graph showing a waveform of a drive voltage in a feed motor that feeds an optical head in a radial direction. FIG. 14C is a graph showing a relationship between a defocus amount of a light spot formed on a photodetector by a light beam reflected by the magneto-optical recording medium and either a time or a shift amount of an objective lens. The term “decentering correction amount” in FIG. 14A denotes a correction current applied to the tracking coil 18b when an offset is generated between a center of a drive shaft of a spindle motor that drives the magneto-optical recording medium and a center of the magneto-optical recording medium.

In a case of recording or reading information with respect to the magneto-optical recording medium, the objective lens 11 (see FIGS. 12 and 13) is positioned first so that the optical axis coincides substantially with an optical axis of a laser beam. Next, a current is applied to the tracking coil 18b as shown in FIG. 14A so that the objective lens 11 follows the track of the magneto-optical recording medium (see FIG. 15), and thus the objective lens 11 shifts in a radial direction. At this time, as shown in FIG. 14B, a voltage corresponding to the value of the current applied to the coil 18b is applied to the feed motor 38.

When the action to follow the track cannot be handled with a shift due to the coil 18b, i.e., when the applied voltage as shown in FIG. 14B reaches a certain level, the feed motor 38 rotates. When the feed motor 38 rotates, as mentioned above, the optical head 43 shifts together with the optical base 19 in a peripheral direction of the magneto-optical recording medium by the feed amount determined by a reduction ratio calculated on the basis of the gear ratio of the gear 39a to the gear 39b and also a pitch of the feed screw 36.

At this time, since the relative position of the objective lens 11 to the magneto-optical recording medium does not change, the shift amount in the radial direction of the objective lens 11 with respect to the optical base 19 is maximized just before a shift caused by the feeder (just before the rotation of the feed motor 38). Moreover, a relative positional deviation of the objective lens 11 with respect to the optical base 19 (or an optical axis of a laser beam) just after the shift due to the feeder is a value obtained by deducting, from a feed amount of the optical head (optical base 19), a shift amount in the radial direction of the objective lens 11 with respect to the optical base 19 just before the shift caused by the feeder.

Next, an optical system of the optical head shown in FIGS. 12 and 13 will be explained below by referring to FIGS. 15 and 16. FIG. 15A is an optical path diagram showing an optical path of the optical head of FIGS. 12 and 13 from a normal direction of the magneto-optical recording medium, and FIG. 15B is an optical path diagram showing an optical path of the optical head of FIGS. 12 and 13 from a direction perpendicular to the normal direction of the magneto-optical recording medium. FIG. 16 is a schematic view showing a light-emitting element and a photodetector composing the optical head shown in FIGS. 12 and 13.

First, an integral unit composing an optical head will be described below. As shown in FIGS. 15A and 15B, an integrated unit 9 composing the optical head includes a silicon substrate 1 on which a semiconductor laser 2 and a photodetector (not shown) are disposed, a hologram element (diffraction grating) 7 formed of resin, and a complex element 8. The complex element 8 includes a beam splitter 8a, a mirror 8b, and a polarized-light separator 8c.

A heat-radiation plate 4 is attached via a silver paste to a surface of the silicon substrate 1, opposing the surface provided with the semiconductor laser 2, and thus heat generated at the silicon substrate 1 is conducted to the heat-radiation plate 4.

As shown in FIG. 16, the silicon substrate 1 is provided with, on the surface having the semiconductor laser 2, focus error signal light-receiving portions 24a and 24b, tracking error signal light-receiving portions 25 and 26, and information signal light-receiving portions 27. Photodetectors are formed at the respective light-receiving portions. The silicon substrate 1 functions as a multi-divided light detector.

Light beams received by the respective light-receiving portions are converted by the photodetectors to electric signals and outputted through output portions 3 and terminals 5. Subtracters 28 and an adder 29 generate a servo signal, a reproduction signal or the like by using the outputted electric signals. Although output paths of the electric signals from the respective photodetectors are shown with separate lines in FIG. 16 for explanation, actually the electric signals from the respective photodetectors are outputted through the output portions 3 and the terminals 5.

The subtracters 28 and the adder 29 are disposed on a substrate (not shown) that is provided independently from the objective lens drive apparatus 14 and the integrated unit 9 (see FIG. 12), or the like. The terminals 5 are connected to the subtracters 28 and the adder 29 via a flexible circuit 35 (see FIG. 12).

In FIGS. 15A, 15B and 16, numeral 6 denotes a resin package for holding the silicon substrate 1, the terminals 5 and the heat-radiation plate 4. The resin package 6 is fixed by an adhesive to the optical base 19 shown in FIG. 12.

Due to this configuration, as shown in FIGS. 15A and 15B, a laser beam emitted from the semiconductor laser 2 is separated into a plurality of light beams by the hologram element 7. Apart of the separated light beams is reflected by the beam splitter 8a of the complex element 8, while the rest passes through the beam splitter 8a.

The light beam reflected by the beam splitter 8a enters the laser monitoring photodetector (not shown) so as to be converted to an electric signal. The drive current of the semiconductor laser 2 is controlled on the basis of this electric signal.

The light beams passing through the beam splitter 8a are reflected by the reflection mirror 10 and enter the objective lens 11 fixed to an objective lens holder (not shown). By the objective lens 11, the plural light beams entering the objective lens 11 are converged as a light spot 32 having a diameter of about 1 micron on a recording surface of a magneto-optical recording medium (magneto-optical disk) 13, and reflected.

Reflected light from the magneto-optical recording medium 13 proceeds backward along the same path to enter the complex element 8 so as to be reflect-separated by the beam splitter 8a. Among the reflected light beams from the magneto-optical recording medium 13, the light beam reflected by the beam splitter 8a is further reflected by the mirror 8b and enters the polarized-light separator &c.

The semiconductor laser 2 is disposed so that the polarization direction of the emitted laser beam is parallel in FIG. 15A. Thereby, light entering the polarized-light separator & is separated into two light beams whose polarization directions cross each other. The separated light beams enter information signal light-receiving portions 27 as shown in FIG. 16, and form light spots 22 and 23.

In FIG. 16, numeral 22 denotes a light spot formed by a main beam (P polarized light), and 23 denotes a light spot formed by a main beam (S polarized light). In the conventional technique, detection of the information signal (magneto-optical disk signal) from the magneto-optical recording medium 13 is carried out by a differential detection method, i.e., by calculating, with a subtracter 28, a difference between light quantity of the main beam (P polarized light) forming the light spot 22 and light quantity of the main beam (S polarized light) forming the light spot 23.

Detection of a prewitt signal is carried out by calculating with the adder 29 a sum of light quantity of the main beam (P polarized light) forming the light spot 22 and light quantity of the main beam (S polarized light) forming the light spot 23.

Among the reflected light from the magneto-optical recording medium 13, a light beam passing through the beam splitter 8a is separated as shown in FIG. 15A into plural light beams by the hologram element 7, and as shown in FIG. 16, converged on the focus error signal light-receiving portions 24a and 24b and the tracking error signal light-receiving portions 25 and 26, thereby forming spots in the respective regions.

In FIGS. 15A and 16, numeral 30 denotes a light spot for detecting a focus error signal, which is formed at the focus error signal light-receiving portion 24a. Numeral 31 denotes a light spot for detecting a focus error signal, which is formed at the focus error signal light-receiving portion 24b. In the conventional technique, focus servo is carried out by so-called SSD (spot size detection), and detection of the focus error signal is carried out by calculating, by means of a subtracter 28, a difference between a light quantity of a light beam received by the focus error signal light-receiving portion 24a and a light quantity of a light beam received by the focus error signal light-receiving portion 24b.

In FIG. 16, numeral 21 denotes a light spot for detecting a tracking error signal, which is formed at the tracking error signal light-receiving portions 25 and 26. The tracking servo is carried out by a so-called push-pull method, and detection of the tracking error signal is carried out by calculating, by means of the subtracter 28, a difference between a light quantity of a light beam received by the tracking error signal light-receiving portion 25 and a light quantity of a light beam received by the tracking error signal light-receiving portion 26.

Regarding the conventional optical head, for obtaining a desired detection signal by using reflected light from the magneto-optical recording medium 13, relative positions of the semiconductor laser 2, the objective lens 11 and the silicon substrate 1 (multi-divided light detector) are adjusted during assembly, thereby setting the initial positions for the respective detection signals.

In the initial position setting for the focus error signal, the position of the silicon substrate 1 in a Z axis direction (the optical axis direction of the emitted laser beam) is adjusted so that the surface of the silicon substrate 1 on which the focus error signal light-receiving portions 24a and 24b are disposed is at a substantial midpoint between a virtual surface including a focus point of the light spot 30 and parallel to the substrate, and also a virtual surface including a focus point of the light spot 31 and parallel to the substrate (see FIG. 15A). The adjustment of the position of the silicon substrate 1 in the Z-axis direction is carried out through designing of the optical base 19 (see FIG. 12) and the resin package 6.

The initial position setting of the tracking error signal is described below by referring to FIGS. 17A and 17B. FIG. 17A is an exploded perspective view showing an initial position adjustment in the optical head shown in FIGS. 12 and 13. FIG. 17B is a perspective view showing an optical head that has been subjected to the position adjustment.

As shown in FIG. 17A, in the initial position setting of a tracking error signal, the objective lens drive apparatus 14 is shifted in a Y direction (tangential direction) and in a X direction (radial direction) in a state that the base 15 is held by an external jig (not shown), and the position of the objective lens drive apparatus 14 is adjusted so that the outputs from the tracking error signal light-receiving portions 25 and 26 will be substantially uniform. This adjustment results in matching of the optical axis of the laser beam emitted from the semiconductor laser 14 shown in FIG. 15 (an axis parallel to the normal of the magneto-optical recording medium 13 from the light-emitting point) and a center axis of the objective lens 11.

In the conventional optical head, as shown in FIG. 17A, the relative inclination between the magneto-optical recording medium (not shown) and the objective lens 11 is also adjusted (skew adjustment). This inclination adjustment is carried out in a state that the base 15 is held by an external jig (not shown).

Specifically, an inclination about the Y axis (radial direction skew) OR and an inclination about the X axis (tangential direction skew) OT in the objective lens drive apparatus 14 are adjusted.

After completing the adjustment, the base 15 is bonded and fixed to the optical base 19 by an adhesive 34. In the thus obtained optical head, adjustment of the focus error signal, the tracking error signal, and the skew adjustment are completed.

However, the optical system of the conventional optical head as shown in FIGS. 13-14 is a so-called finite system. Therefore, as the objective lens 11 is shifted by the objective lens drive apparatus (see FIG. 12) in a radial direction of the magneto-optical recording medium 13, i.e., as the objective lens 11 is apart from the optical axis of the laser beam, the shape of the light spot formed on the recording surface of the magneto-optical recording medium 13 changes, and an off-axis aberration will be generated on the recording surface. When the off-axis aberration is generated, shapes of the light spots 30 and 31 for detecting a focus error signal, which are respectively formed on the focus error signal light-receiving portions 24a and 24b, will be changed as well. As a result, the focus point of the light spot 32 formed on the recording surface of the magneto-optical recording medium 13 is offset to cause defocus. The defocus will be described below by referring to FIGS. 18A and 18B.

FIG. 18A is a graph showing a focus error signal in a case where an optical axis of an objective lens and an optical axis of a laser beam coincide substantially with each other in the optical head shown in FIGS. 12 and 13. FIG. 18B is a graph showing a focus error signal in a case where the optical axis of the objective lens and the optical axis of the laser beam are offset from each other due to a tracking action of the objective lens in the optical head shown in FIGS. 12 and 13. In each of the graphs of FIGS. 18A and 18B, the y-axis indicates a voltage and x-axis indicates a relative distance between the magneto-optical recording medium 13 and the objective lens 11.

FIG. 19 is a block diagram showing a flow of a focus servo in the optical head shown in FIGS. 12 and 13.

The focus error signal shown in FIGS. 18A and 18B is a so-called S-shape signal, and it is generated due to a positional change in the focus direction of the objective lens 11. A point at which the S-shape signal and the GND cross each other is a focus point as a target in the tracking servo of the objective lens 11. Namely, a “focus point” in this specification denotes a target convergent point in a tracking servo of the objective lens 11.

As shown in FIG. 18A, when the center axis of the objective lens and the optical axis of the laser beam coincide with each other, a S-shape signal center that passes through the amplitude center of the S-shape signal becomes a focus point. Therefore, for a focus servo to converge the servo at an intersection of the GND and the S-shape signal, generation of defocus can be suppressed by matching the S-shape signal center and the focus point.

As shown in FIG. 18B, when the center axis of the objective lens and the optical axis of the laser beam are offset from each other, aberration will be generated in the optical spot 32 formed on the recording surface of the magneto-optical recording medium 13, and thus the S-shape signal center is offset from the intersection of the S-shape signal and the GND.

Therefore, in the conventional optical head, subsequent to a calculation-formation of the focus error signal (step S100), an offset amount with respect to the GND is calculated (step S101), and the focusing coil 18a is applied with a current corresponding to the offset amount (step S102), thereby performing focus servo as shown in FIG. 19. Here, the term “offset amount” denotes a difference between the current at the convergent point at this time and the GND (before the focus servo) as shown in FIG. 18B.

However, the focus servo in the step of FIG. 19 is performed only for canceling the offset amount, while the actually-generated defocus is not taken into consideration. Therefore, it is difficult to suppress generation of defocus and off-axis aberration with the focus servo as shown in FIG. 19.

Furthermore, since most of the off-axis aberration is astigmatism, the amount of defocus generated at the time of a shift in a radial direction of the objective lens 11 is increased as the shift amount in the radial direction of the objective lens 11 is great, or as a thickness of the objective lens 11 is decreased. Especially for a portable type disk recording/reproducing apparatus, an optical head is required to be small and thin. Since an objective lens for the optical head is required to be small and thin as well, the off-axis aberration will be increased further.

Moreover, when defocus is generated due to the off-axis aberration, the spot diameter of the light spot 32 formed on the recording surface of the magneto-optical recording medium 13 is increased, and at the same time, the ellipticity is increased. As a result, cross talk (a phenomenon that a signal of an adjacent track leaks into a reproduction signal) is increased during reproduction of a signal of information recorded on the recording surface of the magneto-optical recording medium 13. The cross talk will be increased also by an off-track (an offset of the center of the light spot 32 and the center of the track on the recording surface) that is generated due to the change in the shape of the light spot 32.

The increase of cross talk degrades an ability to read a reproduction signal and also an ability to read a wobble signal having address information or the like, thereby degrading the recording/reproducing performance.

Furthermore, the off-axis aberration changes the shape of the light spot 21 for detecting a tracking error signal. As a result, an offset is generated in the tracking error signal, and this causes an off-track (an offset between the center of the light spot 32 and the center of the track on the recording surface in a tracking servo) in a state being subjected to a tracking servo. This will increase cross talk and degrade recording/reproducing performance of the optical head.

An object of the present invention is to provide an optical head that can suppress generation of an off-axis aberration on the recording surface of a disc-shape recording medium, a disk recording/reproducing apparatus and a method of driving an objective lens.

### DISCLOSURE OF INVENTION

For achieving the above-described object, a first optical head according to the present invention has a light source, an objective lens for converging a light beam from the light source on a recording surface of a disc-shape recording medium, an objective lens drive portion for driving the objective lens in a radial direction and in a focus direction of the disc-shape recording medium, a light-receiving portion for receiving light reflected by the recording surface of the disc-shape recording medium and converting the reflected light into an electric signal, and a signal generation portion for generating a focus error signal and a tracking error signal from the electric signal converted at the light-receiving portion, wherein an offset signal corresponding to a shift amount in the radial direction of the objective lens due to the objective lens drive portion is applied to at least one of the focus error signal and the tracking error signal.

For achieving the above-described object, a second optical head according to the present invention has a light source, an objective lens for converging a light beam from the light source on a recording surface of a disc-shape recording medium, an objective lens drive portion for driving the objective lens in a radial direction and in a focus direction of the disc-shape recording medium, a first light-receiving portion and a second light-receiving portion for receiving light reflected by the recording surface of the disc-shape recording medium and converting the reflected light into electric signals, a signal generation portion for generating a focus error signal from the electric signal converted at the first light-receiving portion and generating a tracking error signal from the electric signal converted at the second light-receiving portion, and a control portion for controlling the objective lens drive portion on the basis of the focus error signal and the tracking error signal, wherein the control portion calculates a defocus amount corresponding to a shift amount in the radial direction of the objective lens due to the objective lens drive portion, generates an offset signal on the basis of the calculated defocus amount, and applies the generated offset signal to the focus error signal so as to control the objective lens drive portion.

Furthermore, for achieving the above-described object, a third optical head according to the present invention has a light source, an objective lens for converging a light beam from the light source on a recording surface of a disc-shape recording medium, an objective lens drive portion for driving the objective lens in a radial direction and in a focus direction of the disc-shape recording medium, a first light-receiving portion and a second light-receiving portion for receiving light reflected by the recording surface of the disc-shape recording medium and converting the reflected light into electric signals, a signal generation portion for generating a focus error signal from the electric signal converted at the first light-receiving portion and generating a tracking error signal from the electric signal converted at the second light-receiving portion, and a control portion for controlling the objective lens drive portion on the basis of the focus error signal and the tracking error signal, wherein the control portion calculates an off-track amount corresponding to a shift amount in the radial direction of the objective lens due to the objective lens drive portion, generates an offset signal on the basis of the calculated off-track amount, and applies the generated offset signal to the off-track error signal so as to control the objective lens drive portion.

For achieving the above-described object, a disk recording/reproducing apparatus according to the present invention has at least the above-mentioned optical head according to the present invention and a feeder for feeding the optical head in the radial direction of the disc-shaped recording medium, wherein the feeder has at least a feed screw for fitting the optical head and feeding the optical head in the radial direction and also a drive motor for rotating the feed screw, and it is configured so that the drive motor rotates to feed the optical head when the shift in the radial direction of the objective lens due to the objective lens drive portion exceeds a certain value, and the feed amount of the optical head by the feeder differs between a time of recording and a time of reproduction on the disc-shaped recording medium.

For achieving the above-described object, a first method of driving an objective lens according to the present invention refers to a method of driving an objective lens by means of an optical head having a light source, an objective lens for converging a light beam from the light source on a recording surface of a disc-shape recording medium, an objective lens drive portion for driving the objective lens in a radial direction and in a focus direction of the disc-shape recording medium, a first light-receiving portion and a second light-receiving portion for receiving light reflected by the recording surface of the disc-shape recording medium and converting the reflected light into electric signals, a signal generation portion for generating a focus error signal from the electric signal converted at the first light-receiving portion and generating a tracking error signal from the electric signal converted at the second light-receiving portion, and a control portion for controlling the objective lens drive portion on the basis of the focus error signal and the tracking error signal. The method includes at least (a) a step of detecting a shift amount in the radial direction of the objective lens due to the objective lens drive portion, (b) a step of calculating a defocus amount corresponding to the detected shift amount, (c) a step of generating an offset signal based on the calculated defocus amount, and (d) a step of applying the generated offset signal to the focus error signal.

For achieving the above-described object, a second method of driving an objective lens according to the present invention refers to a method of driving an objective lens by means of an optical head having a light source, an objective lens for converging a light beam from the light source on a recording surface of a disc-shape recording medium, an objective lens drive portion for driving the objective lens in a radial direction and in a focus direction of the disc-shape recording medium, a first light-receiving portion and a second light-receiving portion for receiving light reflected by the recording surface of the disc-shape recording medium and converting the reflected light into electric signals, a signal generation portion for generating a focus error signal from the electric signal converted at the first light-receiving portion and generating a tracking error signal from the electric signal converted at the second light-receiving portion, and a control portion for controlling the objective lens drive portion on the basis of the focus error signal and the tracking error signal. The method includes at least (a) a step of detecting a shift amount in the radial direction of the objective lens due to the objective lens drive portion, (b) a step of calculating an off-track amount corresponding to the detected shift amount, (c) a step of generating an offset signal based on the calculated off-track amount, and (d) a step of applying the generated offset signal to the tracking error signal.

### BRIEF DESCRIPTION OF DRAWINGS

FIG. 1 is a diagram showing a schematic configuration of an optical head according to a first embodiment of the present invention.

FIG. 2 is a flow chart showing an operation of the optical head according to the first embodiment and a method of driving the objective lens according to the first embodiment.

FIG. 3 is a graph showing a focus error signal for the optical head according to the first embodiment for a case where an optical axis of an objective lens and an optical axis of a laser beam are offset from each other as a result of a tracking operation of the objective lens.

FIG. 4A is a graph showing a waveform of a drive current in a tracking coil for driving the objective lens in a radial direction. FIG. 4B is a graph showing a waveform of a drive voltage in a feed motor that feeds the optical head in a radial direction. FIG. 4C is a graph showing a voltage waveform of an offset signal applied to the focus error signal.

FIGS. 5A-5C are graphs showing control signals for a case of performing decentering correction. Specifically FIG. 5A is a graph showing a waveform of a drive current in a tracking coil that drives an objective lens in a radial direction.

FIG. 5B is a graph showing a waveform of a drive voltage in a feed motor that feeds the optical head in a radial direction, and FIG. 5C is a graph showing a voltage waveform of an offset signal applied to the focus error signal.

FIGS. 6A-6C are graphs referring to a case where an offset signal has a step-wise waveform. Specifically FIG. 6A is a graph showing a waveform of a drive current in a tracking coil that drives an objective lens in a radial direction. FIG. 6B is a graph showing a waveform of a drive voltage in a feed motor that feeds the optical head in a radial direction, and FIG. 6C is a graph showing a voltage waveform of an offset signal applied to the focus error signal.

FIG. 7 is a magnified view showing a tracking error signal light-receiving portion in an optical head according to a second embodiment of the present invention.

FIG. 8 is a flow chart showing an operation of the optical head according to the second embodiment and a method of driving the objective lens according to the second embodiment.

FIG. 9A is a graph showing a tracking error signal for a case where an optical axis of an objective lens coincides substantially with an optical axis of a laser beam. FIG. 9B is a graph showing a tracking error signal for a case where an optical axis of an objective lens is offset from an optical axis of a laser beam as a result of a tracking operation of an objective lens.

FIG. 10 is a flow chart showing an operation of an objective lens according to a third embodiment of the present invention, and a method of driving an objective lens according to the third embodiment.

FIG. 11A is a graph showing a waveform of a drive current in a tracking coil and a waveform of a drive voltage in a feed motor during a reproduction. FIG. 11B is a graph showing a waveform of a drive current in a tracking coil and a waveform of a drive voltage in a feed motor during a recording.

FIG. 12 is an exploded perspective view showing a configuration of a conventional optical head.

FIG. 13 is an exploded perspective view showing a schematic configuration of a feeder of a conventional optical head.

FIG. 14A is a graph showing a waveform of a drive current in a tracking coil that drives an objective lens in a radial direction. FIG. 14B is a graph showing a waveform of a drive voltage in a feed motor that feeds an objective lens in a radial direction. FIG. 14C is a graph showing a relationship between a defocus amount of a light spot formed on a photodetector by a light beam reflected by a magneto-optical recording medium and either a time or a shift amount of an objective lens.

FIG. 15A is an optical path diagram showing an optical path of the optical head shown in FIGS. 12 and 13 from a normal direction of the magneto-optical recording medium. FIG. 15B is an optical path diagram showing an optical path of the optical head shown in FIGS. 12 and 13 from a direction perpendicular to the normal direction of the magneto-optical recording medium.

FIG. 16 is a schematic view showing light-emitting elements and photodetectors composing the optical head shown in FIGS. 12 and 13.

FIG. 17A is an exploded perspective view showing an initial position adjustment in the optical head shown in FIGS. 12 and 13. FIG. 17B is a perspective view showing an optical head that has been subjected to the positional adjustment.

FIG. 18A is a graph showing a focus error signal for a case where an optical axis of an objective lens and an optical axis of a laser beam coincide substantially with each other in the optical head shown in FIGS. 12 and 13. FIG. 18B is a focus error signal for a case where an optical axis of an objective lens is offset from an optical axis of a laser beam as a result of a tracking operation of the objective lens.

FIG. 19 is a block diagram showing a flow of a focus servo in the optical head shown in FIGS. 12 and 13.

### PREFERRED EMBODIMENT OF THE INVENTION

(First Embodiment)

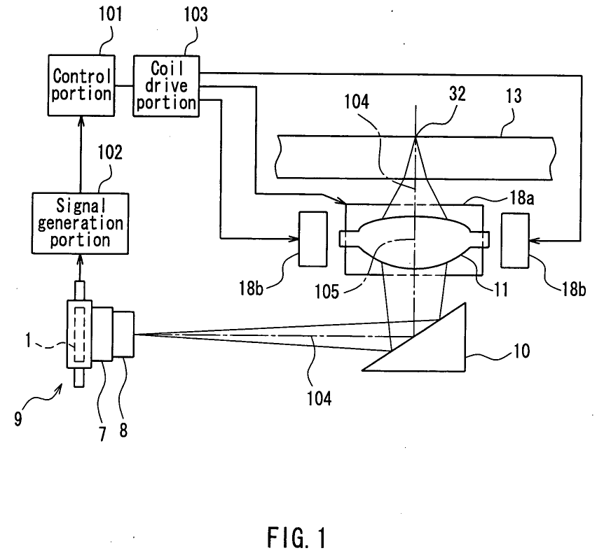

An optical head, a disk recording/reproducing apparatus and a method of driving an objective lens according to a first embodiment of the present invention will be described below by referring to FIGS. 1-6.

FIG. 1 is a diagram showing a schematic configuration of an objective lens according to the first embodiment. FIG. 1 shows that, similar to the above-described conventional examples, the objective lens according to the first embodiment is used to record and reproduce information with respect to a magneto-optical recording medium 13 as a disc-shape recording medium. In the first embodiment, the magneto-optical recording medium 13 is a magneto-optical disk.

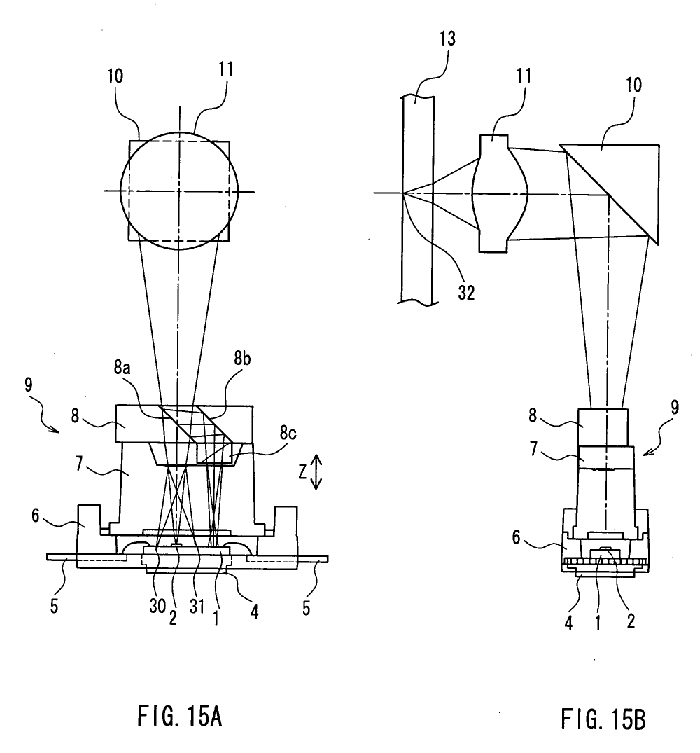

The optical head according to the first embodiment has an integrated unit 9, an objective lens 11, and an objective lens drive portion for driving the objective lens 11 in a radial direction and in a focus direction of the magneto-optical recording medium 13. The integrated unit 9 and the objective lens 11 are the same as those shown in FIGS. 15A and 15B.

Similar to the integrated unit shown in FIGS. 15A and 15B, the integrated unit 9 has a silicon substrate 1, a hologram element 7 and a complex element 8. On the silicon substrate 1, a semiconductor laser as a light source, a focus error signal light-receiving portion, a tracking error signal light-receiving portion and an information signal light-receiving portion are disposed. Light reflected by the recording surface of the magneto-optical recording medium 13 is received by the respective light-receiving portions and converted to electric signals.

The lens drive portion has a focusing coil 18a for driving the magneto-optical recording medium 13 in the focus direction, a tracking coil 18b for driving the magneto-optical recording medium 13 in the radial direction, and a coil drive portion 103 for supplying current to the two coils 18a and 18b.

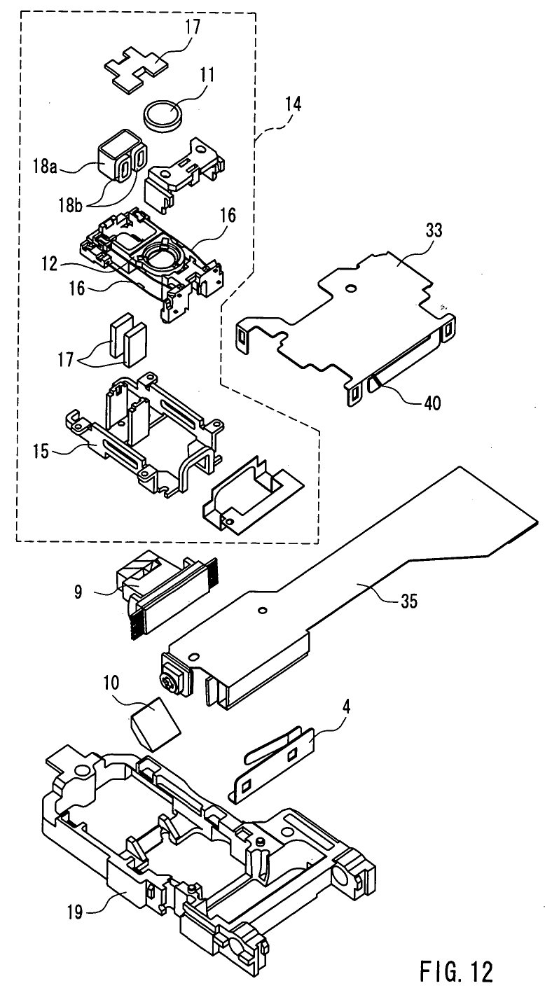

In the first embodiment, the lens drive portion is similar to the lens drive apparatus 14 shown in FIG. 12. Thus, the focusing coil 18a and the tracking coil 18b are similar to those shown in FIG. 12. The coil drive portion 103 is a drive circuit provided in the flexible circuit 35 shown in FIG. 12.

Furthermore, the optical head according to the first embodiment has a signal generation portion 102 for generating various controlling signals, reproduction signals or the like, from electric signals converted at the respective light-receiving portions, and a control portion 101 that is used, e.g., for controlling the focusing coil 18a and the tracking coil 18b on the basis of the control signal generated at the signal generation portion 102.

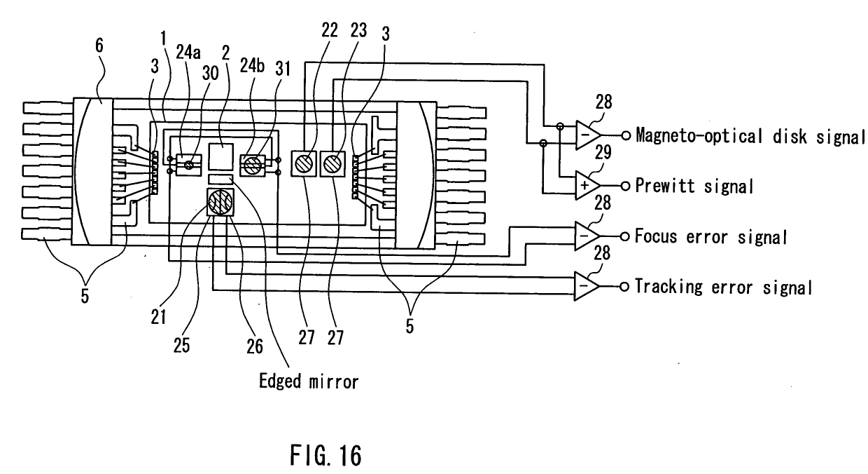

In the first embodiment, the signal generation portion 102 is composed of subtracters and an adder that are shown in FIG. 16, and it generates a focus error signal, a tracking error signal, a magneto-optical disk signal, a prewitt signal or the like, as shown in FIG. 16. Similar to the conventional example, the control portion 101 and the signal generation portion 102 are disposed on a substrate (not shown) provided independently from the lens drive portion, the integrated unit or the like. Not being limited to this embodiment, the control portion 101 and the signal generation portion 102 of the present invention can be disposed on a flexible circuit (see FIG. 12) or on a silicon substrate (see FIG. 16) functioning as a multi-divided light detector.

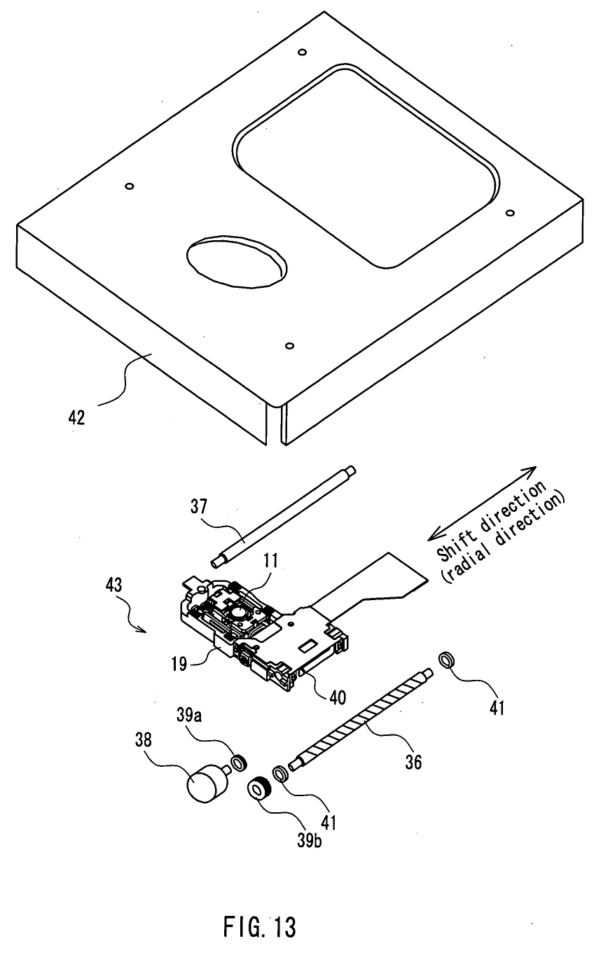

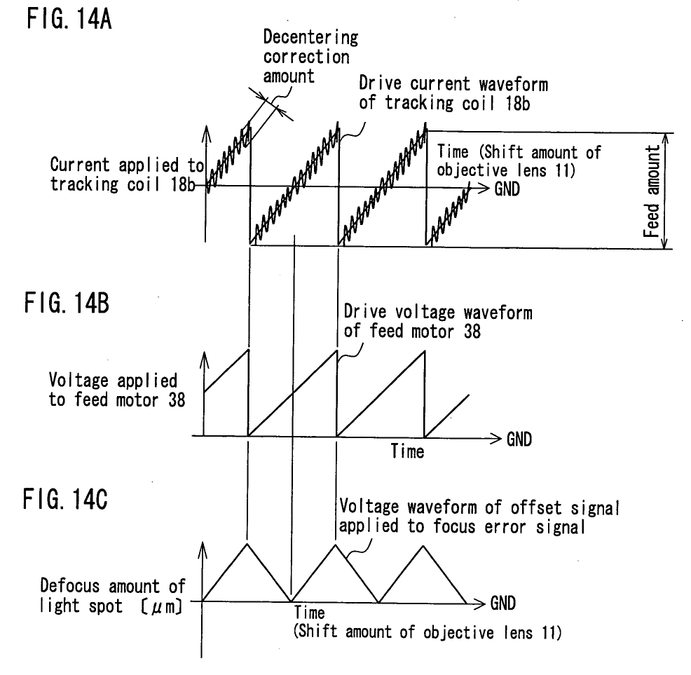

As mentioned above, the optical head according to the first embodiment is configured similarly to the conventional optical head shown in FIGS. 12, 15A and 15B. Moreover, the feeder shown in FIG. 13 is attached to the optical head of the first embodiment so as to configure a disk recording/reproducing apparatus according to the first embodiment.

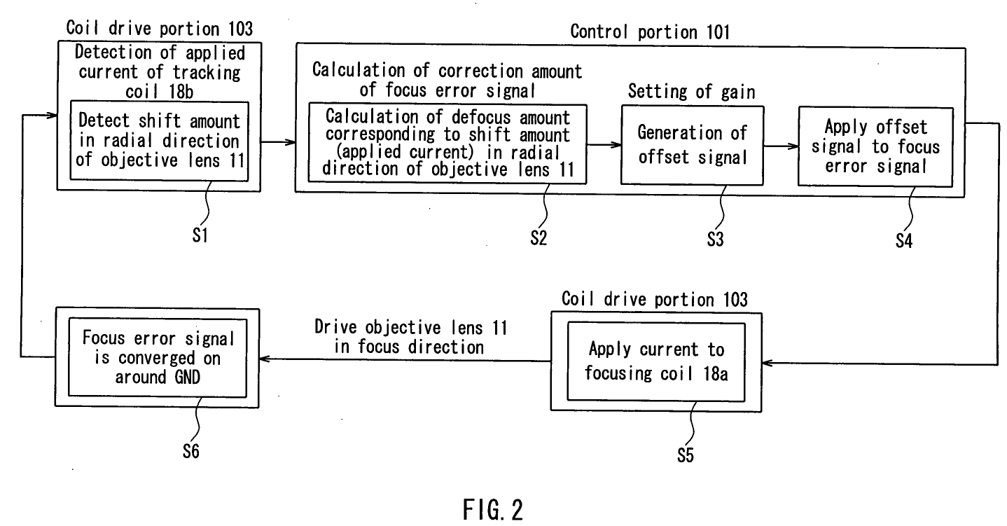

However, the optical head according to the first embodiment is different from a conventional optical head with respect to focusing control of the objective lens 11 by means of the control portion 101, and this can provide effects the conventional examples cannot obtain. This will be described below by referring to FIGS. 2-4.

FIG. 2 is a flow chart showing an operation of the optical head according to the first embodiment and a method of driving the objective lens according to the first embodiment.

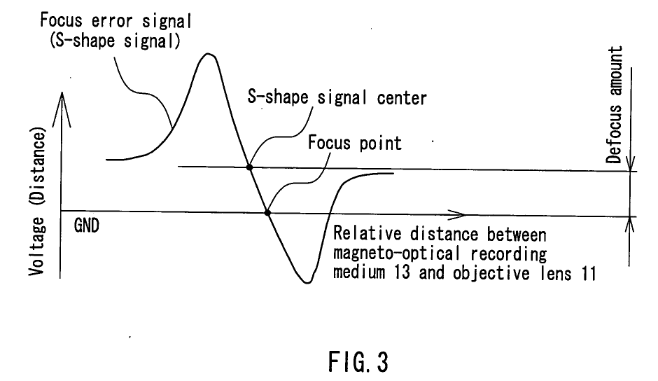

FIG. 3 is a graph showing a focus error signal for a case where an objective lens in the optical head according to the first embodiment performs a tracking operation so that an optical axis of the objective lens and an optical axis of a laser beam are offset from each other.

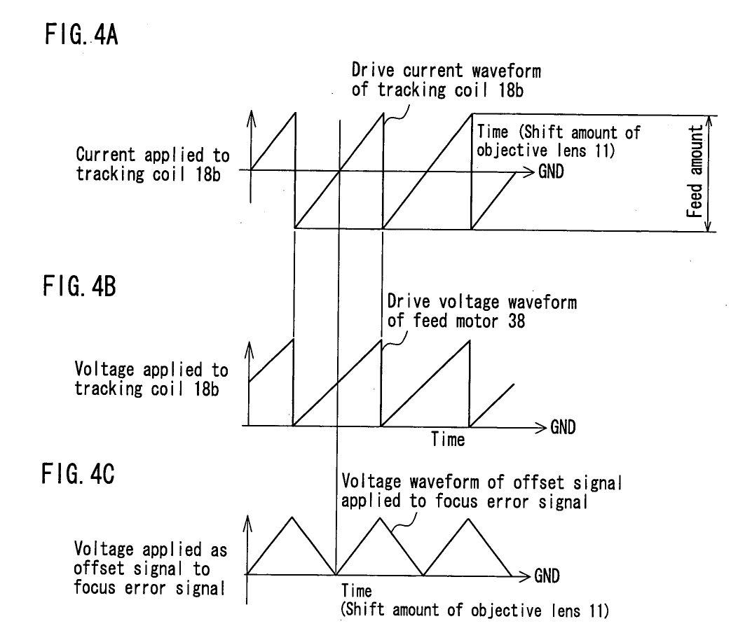

FIG. 4A is a graph showing a waveform of a drive current in a tracking coil that drives the objective lens in a radial direction. FIG. 4B is a graph showing a waveform of a drive voltage in a feed motor that feeds the optical head in a radial direction. FIG. 4C is a graph showing a voltage waveform of an offset signal applied to the focus error signal.

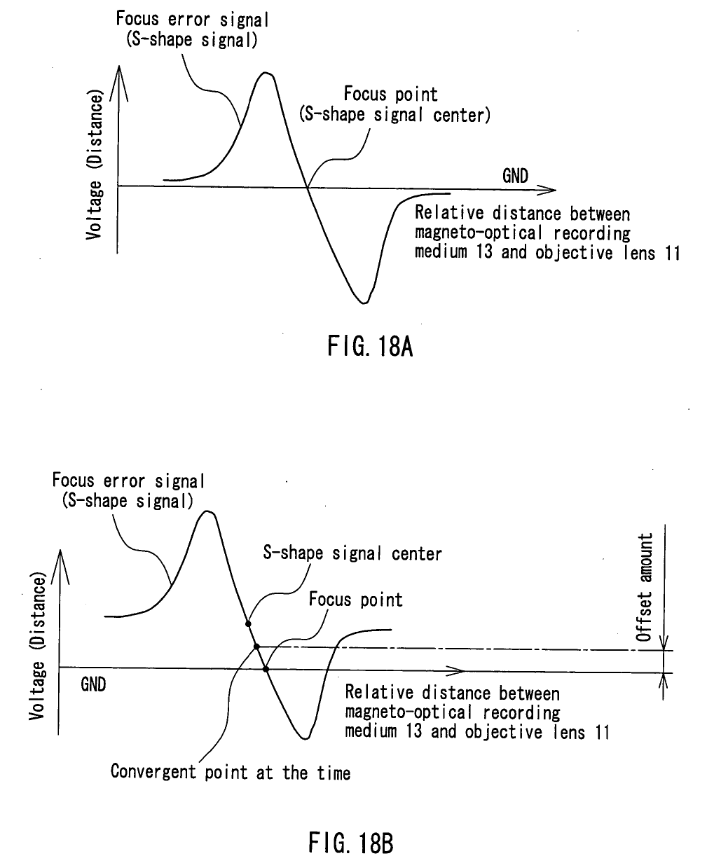

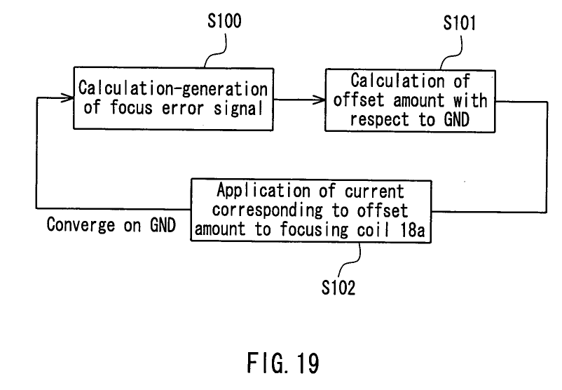

First, the objective lens 11 is positioned so that the optical axis 105 coincides with an optical axis 104 of a semiconductor laser as a light source. At this time, a focus error signal as shown in FIG. 18A is obtained.

In this specification, the optical axis 104 of a light source (semiconductor laser) denotes an axis that passes through a light-emitting point of the semiconductor laser and is perpendicular to the recording surface of the magneto-optical recording medium 13 (disc-shape recording medium) when being bent by a reflection mirror 10 used in an embodiment as shown in FIG. 1. In an embodiment where a reflection mirror 10 is not used, an optical axis of a light source denotes an axis of light passing through a light-emitting point of a light source and perpendicular to a recording surface of a magneto-optical recording medium (disc-shape information recording medium).

Next, the objective lens is shifted in a radial direction of the magneto-optical recording medium 13 by the tracking coil 18b, and thereby a focus error signal as shown in FIG. 3 is obtained. For the focus error signal as shown in FIG. 3, a center of a S-shape signal is offset from an intersection of the S-shape signal and a GND, as shown in FIG. 18B. A difference between the focus point and the center of the S-shape signal, i.e., a difference between the voltage at the S-shape signal center and the voltage of the GND is a defocus amount corresponding to the shift amount in a radial direction of the objective lens 11.

Unlike the conventional example, a shift amount in a radial direction of the objective lens 11 is detected first as shown in FIG. 2 (step S1) at this time in the first embodiment. Specifically, the shift amount in a radial direction of the objective lens 11 is calculated by the coil drive portion 103 on the basis of the applied current of the tracking coil 18b and a radial direction sensitivity at the objective lens drive portion (radial direction shift amount/applied current). In the specification, a shift amount in a radial direction of the objective lens 11 denotes a distance from the optical axis of the above-mentioned light source to the optical axis of the objective lens 11.

It is also possible in the first embodiment to detect the shift amount in a radial direction of the objective lens 11 by using an external position sensor. An example of the external position sensor is composed of a light-emitting element such as a LED and a semiconductor device and also a photodetector.

Next, a defocus amount (see FIG. 3) corresponding to the shift amount in a radial direction of the objective lens 11 is calculated by the control portion 101 (step S2). In the first embodiment, calculation of the defocus amount by the control portion 101 is performed by obtaining a ratio (converted score) of the defocus amount to the shift amount previously through an experiment or a simulation, and multiplying the shift amount by the converted score.

Next, an offset signal is generated by the control portion 101 on the basis of the calculated defocus a mount (step S3). Specifically, the offset signal is generated by multiplying a defocus amount by a gain. The gain is set based on the calculated defocus amount and a focus direction sensitivity (defocus amount/applied current value) of the objective lens drive portion.

Next, the offset signal is applied to the focus error signal by the control portion 101 (step S4). As shown in FIGS. 4A, 4B and 4C, the voltage applied as the offset signal to the focus error signal changes in accordance with the shift amount in a radial direction of the objective lens 11. Later, a drive current based on the focus error signal applied with the offset signal is applied to the focusing coil 18a by the coil drive portion 103 (step S5).

As a result, the S-shape signal shown in FIG. 18B is in a state of shifting in parallel to the GND, and thus the S-shape signal center becomes a focus point. Therefore, the objective lens 11 is driven in a focus direction by the control portion 101 so that the focus error signal is converged about on the GND, i.e., the focus error signal is converged on the S-shape signal center (step S6).

As a result, the defocus amount becomes substantially zero, thereby suppressing deformation of the light spot 32 and generation of aberration that are caused by the shift in the radial direction of the objective lens 11.

As mentioned above, in the optical head according to the first embodiment, the focus error signal is applied with an offset signal so as to change the focus point, thereby correcting optically the aberration and the shape of the light spot 32 on the recording surface of the magneto-optical recording medium 13. Therefore, generation of the off-axis aberration on the recording surface of the magneto-optical recording medium 13 can be suppressed by using the optical head of the first embodiment. Moreover, since the influence of the off-axis aberration can be decreased, the objective lens 11 can be downsized and decreased in the thickness, thereby providing small and thin optical head and disk recording/reproducing apparatus.

Furthermore, since generation of off-axis aberration on the recording surface of the magneto-optical recording medium 13 can be suppressed, degradation in the reproduction signal and in the servo signal caused by the shift in the radial direction of the objective lens 11 can be improved remarkably. In addition, it will improve remarkably the recording performance and the reproduction performance of the optical head and the disk recording/reproducing apparatus.

It should be noted particularly that reading of a wobble signal recorded on the magneto-optical recording medium 13 is affected easily by cross talk due to the defocus of the light spot 32 formed in the recording surface of the magneto-optical recording medium 13, and thus the wobble signal will be degraded considerably at a time of a shift in a radial direction of the objective lens 11. However, according to the first embodiment, since the focus point of the light spot 32 is changed in accordance with the shift amount in the radial direction of the objective lens 11, the detection performance of the wobble signal at the time that the objective lens 11 shifts in the radial direction can be improved remarkably.

It is also possible to enlarge the maximum value of the shift amount in the radial direction of the objective lens 11 due to the tracking coil 18b in comparison with a conventional optical head. Thereby, an intermittent rate (inoperative time rate) of the feed motor 38 in a feeder that drives the entire optical head in a radial direction can be increased, thereby improving the reading and recording ability of the disk recording/reproducing apparatus and also realizing significant energy saving.

In the first embodiment, an offset signal is generated from a defocus amount and applied to the focus error signal so as to carry out a focusing servo. In an alternative embodiment, a drive current of the focusing coil 18a can be corrected in accordance with the defocus amount so as to apply the corrected drive current to the focusing coil 18a. This alternative embodiment also can provide the above-mentioned effect.

It is also possible in the first embodiment that a decentering amount (an offset amount of the center of the magneto-optical recording medium with respect to the center of the drive axis of a spindle motor that drives the magneto-optical recording medium) in the magneto-optical recording medium 13 with respect to the rotation center is calculated by the control portion 101, thereby generating an offset signal on the basis of the calculated decentering amount and the calculated defocus amount.

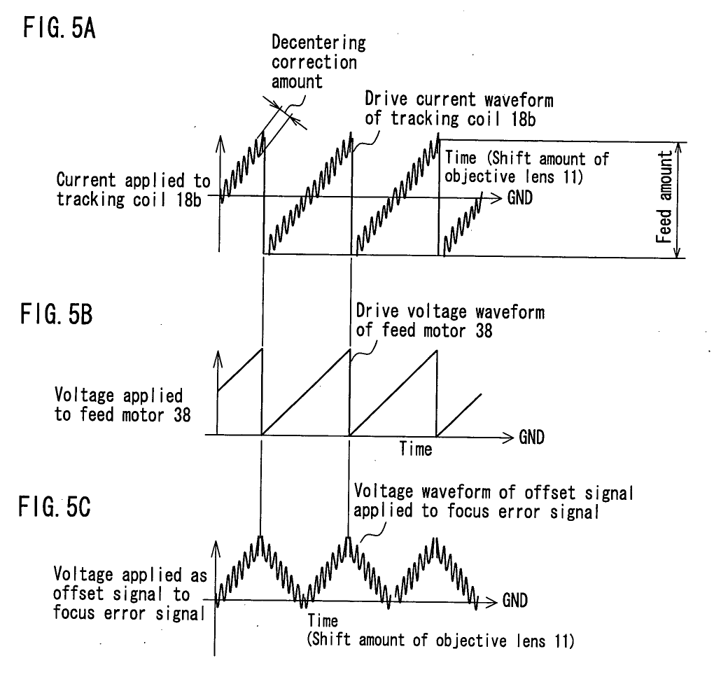

FIGS. 5A-5C are graphs showing control signals for a case of performing decentering correction. Specifically, FIG. 5A is a graph showing a waveform of a drive current in a tracking coil that drives an objective lens in a radial direction. FIG. 5B is a graph showing a waveform of a drive voltage in a feed motor that feeds the optical head in a radial direction. FIG. 5C is a graph showing a voltage waveform of an offset signal applied to the focus error signal.

As shown in FIGS. 5A-5C, a more accurate optical head and optical disk recording/reproducing apparatus can be realized by detecting a decentering that causes a deflection in a radial direction of the recording/reproducing signal track position of the magneto-optical recording medium 13 during recording and reproducing, and by allowing the objective lens 11 to follow the decentering.

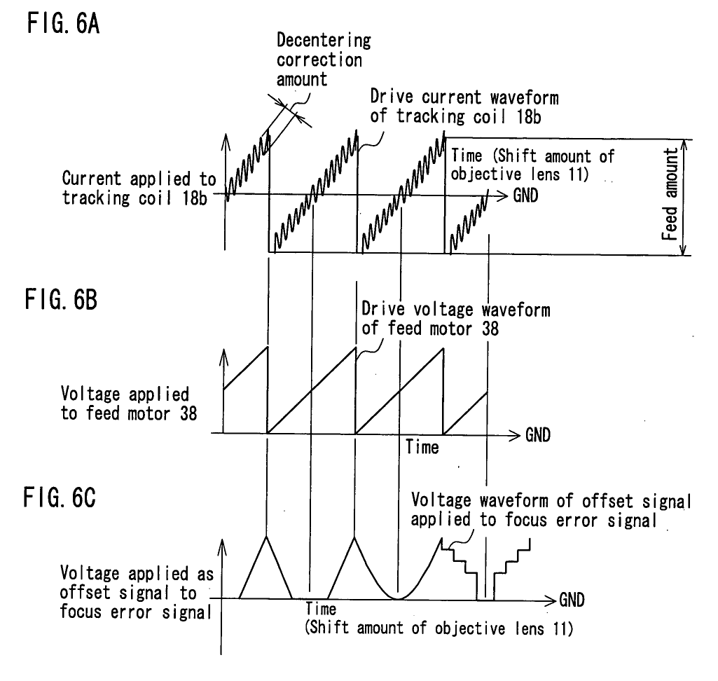

In the first embodiment, the offset signal is generated based on a defocus amount corresponding to the shift amount of the objective lens 11. Alternatively, as shown in FIG. 6, the voltage waveform of the offset signal applied to the focus error signal can be corrected arbitrarily to a step-wise waveform. Similarly, the voltage waveform of the offset signal can be nonlinear or a waveform provided with a dead band.

FIGS. 6A-6C are graphs for a case where an offset signal has a step-wise waveform. Specifically, FIG. 6A is a graph showing a waveform of a drive current in a tracking coil that drives an objective lens in a radial direction. FIG. 6B is a graph showing a waveform of a drive voltage in a feed motor that feeds the optical head in a radial direction, and FIG. 6C is a graph showing a voltage waveform of an offset signal applied to the focus error signal.

An optical head according to the first embodiment can be provided further with a temperature detector for detecting the temperature around the optical head. In this case, the control portion 101 can generate an offset signal on the basis of the detected ambient temperature and the defocus amount. This embodiment enables correction of the aberration and the shape of the light spot 32 affected by the temperature change and also correction of the defocus of the light spot 32, thereby improving the recording/reproducing performance.

In the first embodiment, the control portion 101 generates the offset signal by changing the defocus amount as shown in step S3 in FIG. 2. In an alternative embodiment, the degree in the changing offset amount can be differentiated between a time of recording and a time of reproduction. Specifically, the value of a gain (step S3 in FIG. 2) to be multiplied by the defocus amount during a recording can be increased in comparison with the gain value during a reproduction.

As mentioned above, since the off-axis aberration is generated on the recording surface of the magneto-optical recording medium in accordance with the shift amount of the objective lens 11, a servo signal and a reproduction signal must be taken into consideration during a reproduction. Therefore, the shift amount in the radial direction of the objective lens due to the lens drive portion is increased during a reproduction, and thus cross talk will occur in the reproduction signal, resulting in difficulty in increasing the shift amount.

However, since only the servo signal must be taken into consideration during a recording, the shift amount can be enlarged in comparison with the time of a reproduction. Therefore, as mentioned above, the gain value to be multiplied by the defocus amount during a recording (step S3 in FIG. 2) can be increased in comparison with the gain value during a reproduction.

In this case, a time for not operating the feed motor 38 (intermittent rate) can be improved during a recording, and thus power consumption of the optical head and the disk recording/reproducing apparatus can be decreased considerably.

In the first embodiment, the degree in change of the offset amount can be set in accordance with the type of the recording medium that is specified by at least one of a reflection, a track density (track pitch), a disk thickness, a disk diameter and a track groove shape.

Furthermore in the first embodiment, the feed amount of the feed motor 38 (see FIG. 13), i.e., the voltage applied to the feed motor 38 in correspondence with the feed amount can be set differently between a time of recording and a time of reproduction.

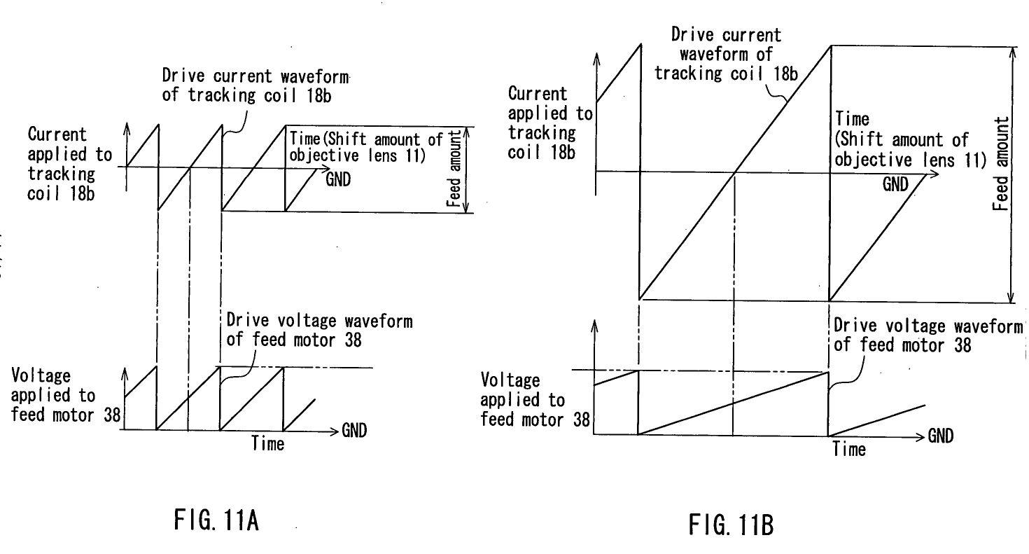

For example, as shown in FIGS. 11A and 11B, the intermittent rate of the feed motor 38 can be improved by increasing the feed amount during a recording in comparison with that during a reproduction, thereby realizing a disk recording/reproducing apparatus that is further effective in power saving.

FIG. 11A is a graph showing a waveform of a drive current in a tracking coil and a waveform of a drive voltage in a feed motor during a reproduction. FIG. 11B is a graph showing a waveform of a drive current in a tracking coil and a waveform of a drive voltage in a feed motor during a recording. In FIGS. 1A and 1B, the shift amount during a recording is set to be greater than that during a reproduction.

In contrast, a recording margin with respect to the feed amount can be enlarged by decreasing a feed amount during a recording in comparison to that during a reproduction, thereby decreasing the core size (not shown) of the magnetic head. This will contribute to a further downsizing of a disk recording/reproducing apparatus.

Furthermore, the feed amount of the feed motor 38 (see FIG. 13) can be set in accordance with the type of the recording medium specified by at least one of a reflection, a track density (track pitch), a disk thickness, a disk diameter and a track groove shape.

(Second Embodiment)

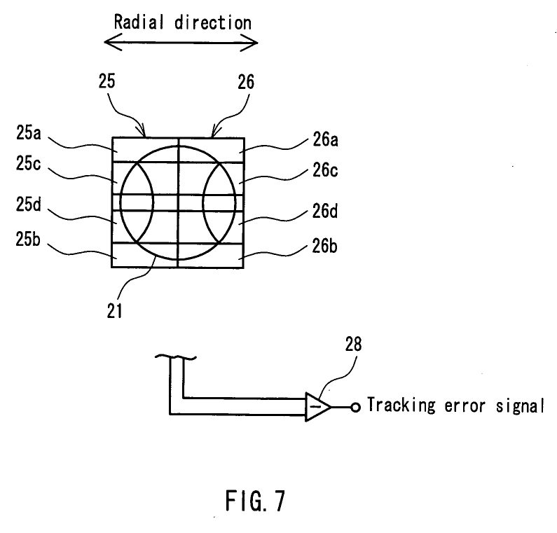

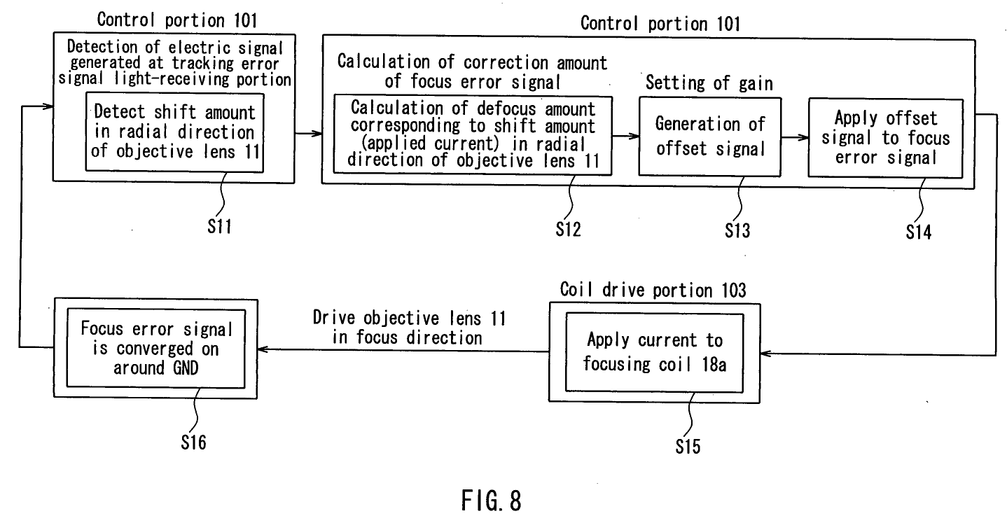

Next, an optical head, a disk recording/reproducing apparatus and a method of driving an objective lens according to a second embodiment of the present invention will be described below by referring to FIGS. 7 and 8. FIG. 7 is a magnified view showing a tracking error signal light-receiving portion in the optical head according to the second embodiment. FIG. 8 is a flow chart showing an operation of the optical head according to the second embodiment and a method of driving the objective lens according to the second embodiment.

The optical head according to the second embodiment is similar to that of the first embodiment, except that the detection of the shift amount in the radial direction of the objective lens due to the lens drive portion is carried out on the basis of the electric signal from the tracking error signal light-receiving portion.

Similar to the conventional example shown in FIG. 16, the tracking error signal light-receiving portion of the first embodiment is composed of two light-receiving portions 25 and 26, and each of the light-receiving portions is provided with one photodetector. In the second embodiment, as shown in FIG. 7, the tracking error signal light-receiving portions 25 and 26 have respectively a plurality of light-receiving regions (25a-25d, 26a-26d), and each of the light-receiving regions is provided with a photodetector.

In the second embodiment, the shift amount in a radial direction of the objective lens is detected by calculating the electric signals converted at the light-receiving regions 25a, 25b, 26a and 26b. When the electric signals converted at the light-receiving regions 25a, 25b, 26a and 26b have voltage values of 25aV, 25bV, 26aV, and 26bV respectively, the shift amount in the radial direction of the objective lens can be calculated by the following equation (1).

(Shift amount)=((25aV+25bV)−(26aV+26bV))k (1)

In the equation (1), ‘k’ is an arbitrary scale factor and also a numerical value that can be changed arbitrarily. Generally, when a light-receiving portion receives a light beam, it generates a current corresponding to a radiation sensitivity (current/light quantity conversion factor), and further generates a voltage corresponding to the light quantity by the current/voltage conversion. Therefore, the calculation of the shift amount in the radial direction based on the equation (1) can be performed by using a current value in place of a voltage value.

Therefore in the second embodiment, the objective lens is driven in the focus direction as shown in FIG. 8. The shift in the focus direction of the objective lens as shown in FIG. 8 is carried out similarly to the first embodiment shown in FIG. 2, except that detection of the shift amount in the radial direction of the objective lens in the step S11 is carried out by detecting the electric signal generated at the tracking error signal light-receiving portion. In the second embodiment, an offset signal corresponding to the shift amount in the radial direction of the objective lens is applied to the focus error signal.

Though the shift amount is detected by using an electric signal generated at the tracking error signal light-receiving portion in the second embodiment, the optical head according to the second embodiment is not limited thereto. Alternatively, the shift amount can be detected by means of an electric signal generated at a light-receiving portion other than the tracking error signal light-receiving portion. Alternatively, a separate light-receiving portion not shown in FIG. 16 can be provided to detect the shift amount.

As mentioned above, the second embodiment can provide the effect as described in the first embodiment, since an offset signal corresponding to the shift amount in the radial direction of the objective lens is applied to the focus error signal. Furthermore in the second embodiment, the shift amount in the radial direction of the objective lens can be detected on the basis of the electric signal generated from the light reflected by the recording surface of the magneto-optical recording medium. Since this configuration enables direct detection of the positional relationship between the objective lens and the magneto-optical recording medium, the accuracy in the position detection for an optical disk can be improved further than that according to the first embodiment.

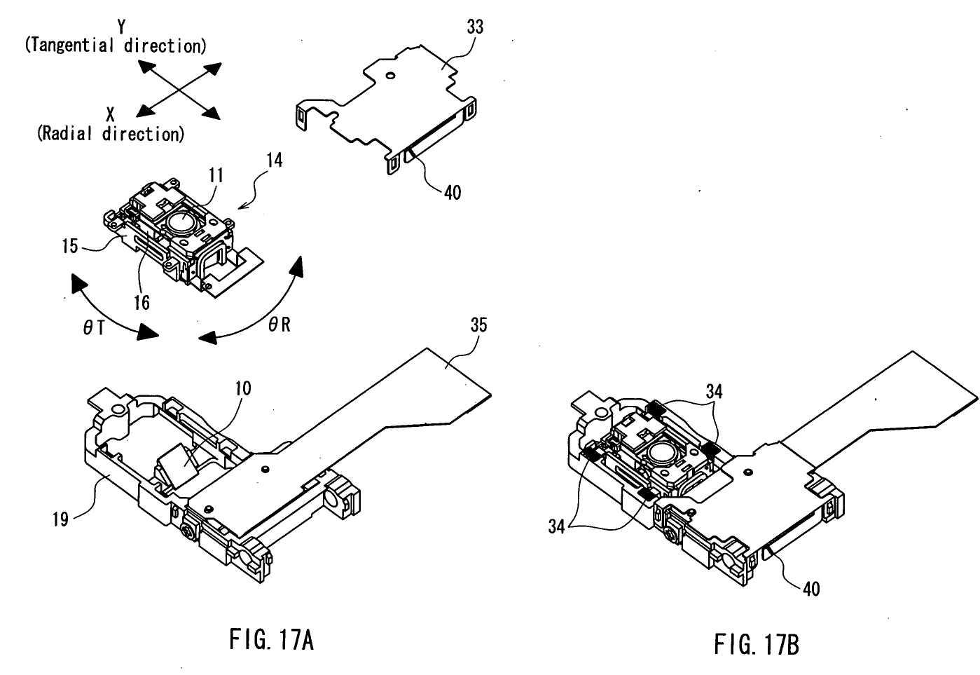

In the second embodiment, when the electric signals converted at the light-receiving portions 25c, 25d, 26c and 26d have voltage values of 25cV, 25dV, 26cV, and 26cV respectively, the tracking error signal can be obtained by performing the following equation (2) by a subtracter composing the signal generation portion. (Voltage of tracking error signal)=(25cV+25dV)−(26cV+26dV). (2) In the optical head according to the second embodiment, the X-Y plane (see FIG. 17A) is adjusted so that the shift amount obtained based on the equation (1) will be substantially zero. Alternatively, the adjustment of the X-Y plane can be carried out so that the value of (25aV−26aV) or (25bV−26bV) will be substantially zero.

The Y-direction is adjusted so that the groove-mixed signal (a signal generated by so called “±first-order light”) that will be mixed in a signal by (25aV+25bV) and a signal by (26aV+26bV) will be minimum. Alternatively, the Y-axis direction can be adjusted so that the groove-mixed signals to be mixed respectively in 25aV 26aV, 25bV and 26bV will be minimum.

(Third Embodiment)

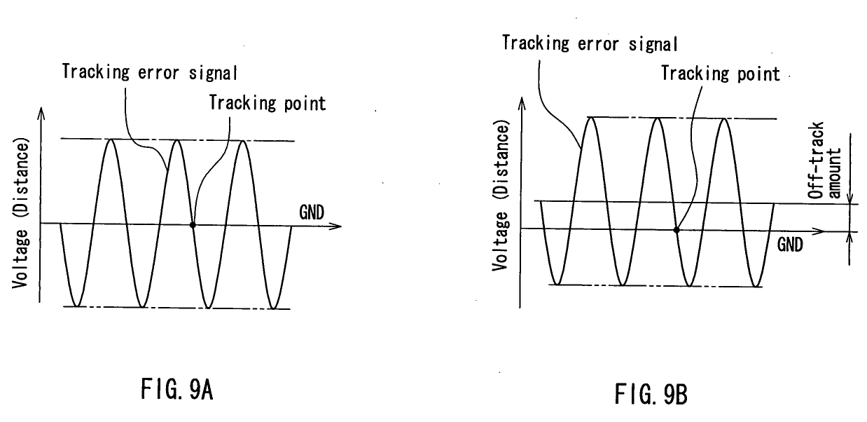

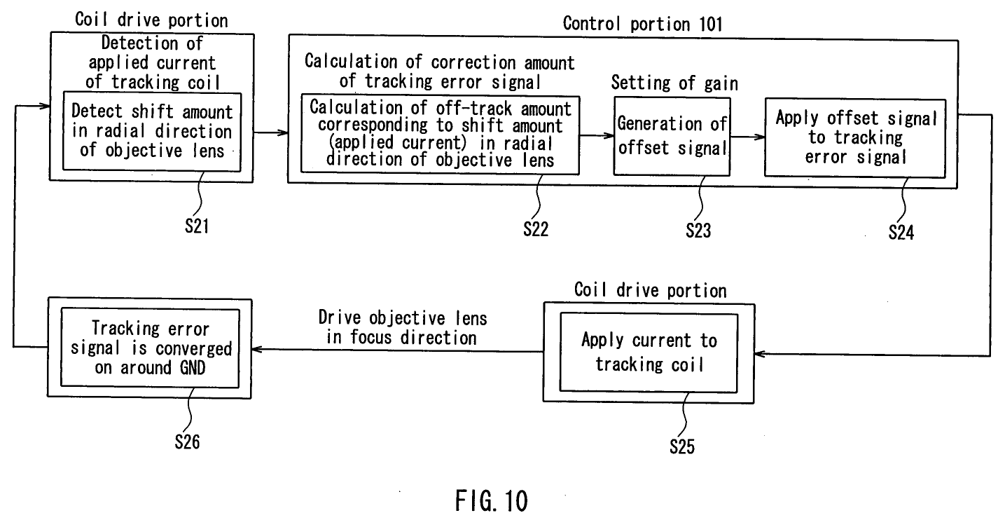

Next, an optical head and a disk recording/reproducing apparatus and a method of driving an objective lens according to a third embodiment of the present invention will be described below by referring to FIGS. 9 and 10.

The optical head and the disk recording/reproducing apparatus according to the third embodiment have configurations similar to those of the first and second embodiments. Similar to the first and second embodiments, a defocus amount is calculated in accordance with a shift amount in a radial direction of the objective lens due to the objective lens drive portion, and an offset signal is formed based on the defocus amount.

However, the third embodiment is distinguished from the first and second embodiments in that the generated offset signal is applied to a tracking error signal and that an off-track generated in accordance with the shift amount in the radial direction of the objective lens is corrected. The third embodiment will be described below by referring to FIGS. 9 and 10.

FIG. 9A is a graph showing a tracking error signal for a case where an optical axis of an objective lens coincides substantially with an optical axis of a laser beam. FIG. 9B is a graph showing a tracking error signal for a case where an objective lens performs a tracking operation and thus an optical axis of the objective lens and an optical axis of a laser beam are offset from each other. In each of the graphs shown in FIGS. 9A and 9B, the y-axis indicates a voltage and the x-axis indicates a relative distance between the magneto-optical recording medium 13 and the objective lens 11. FIG. 10 is a block diagram showing a flow of a tracking servo in the optical head according to the third embodiment.

The tracking error signal shown in FIGS. 9A and 9B is generated due to the positional change in the radial direction of the objective lens. A point at which the tracking error signal and a GND cross each other is a tracking point in the objective lens.

As shown in FIG. 9A, when the center axis of the objective lens and the optical axis of the laser beam coincide with each other, the GND will be an intermediate value between the maximum and minimum of the tracking error signal. Therefore, tracking servo will be carried out so that the tracking error signal is converged on an intermediate value between the maximum and minimum of the tracking error signal.

As shown in FIG. 9B, when the center axis of the objective lens and the optical axis of the laser beam are offset from each other, the shape of the light spot formed on a recording surface of the magneto-optical recording medium will be changed, and thus a curve to indicate the tracking error signal is shifted upward in parallel. This shift amount denotes an off-track amount. Therefore, the cross talk will be increased when the tracking servo is carried out to converge the tracking error signal on an intermediate value between the maximum and minimum as described above.

Therefore in this embodiment, a tracking servo is carried out as shown in FIG. 10. FIG. 10 is a flow chart showing an operation of the optical head according to the third embodiment and a method of driving the objective lens according to the third embodiment.

First, the objective lens is positioned so that the optical axis coincides with the optical axis of a semiconductor laser as a light source. At this time, a tracking error signal as indicated in FIG. 9A is obtained.

Next, when the objective lens is shifted in a radial direction of the magneto-optical recording medium by a tracking coil, a focus error signal as shown in FIG. 9B is obtained. At this time, as shown in FIG. 10, a shift amount in a radial direction of the objective lens is detected (step S21). Specifically, the shift amount in the radial direction of the objective lens 11 is calculated by the coil drive portion, based on the applied current of the tracking coil and a radial direction sensitivity (radial direction shift amount/applied current) in the objective lens drive portion.

Alternatively in the third embodiment, the shift amount in the radial direction of the objective lens 11 can be detected by means of an external position sensor. Alternatively, the detection can be carried out by means of an electric signal generated at a light-receiving portion as shown in the second embodiment.

Then, by the control portion, an off-track amount (see FIG. 9B) corresponding to the shift amount in the radial direction of the objective lens is calculated (step S22). In the third embodiment, the calculation of the off-track amount by the control portion is carried out by previously measuring a ratio (converted score) of the off-track amount to the shift amount through an experiment, and by multiplying the shift amount by this converted score.

Next, an offset signal is generated on the basis of the calculated off-track amount by means of the control portion (step S23). Specifically, the offset signal is generated by multiplying the off-track amount by a gain. The gain is set based on the calculated off-track amount and the radial direction sensitivity of the above-mentioned objective lens drive portion.

Next, the offset signal is applied to the tracking error signal by the control portion (step S24). Later, by means of the coil drive portion, the tracking coil is applied with a drive current based on the tracking error signal applied with the offset signal (step S25).

As a result, the S-shape signal shown in FIG. 9B is in a state shifting in parallel toward the GND, and the objective lens is driven in a radial direction by the control portion (step S26), so that the tracking error signal is converged on around the GND. Therefore, the off-track amount will be substantially zero, and thus the change in shape of the light spot 32 generated due to the shift in the radial direction of the objective lens 11 can be suppressed.

As mentioned above, in the optical head according to the third embodiment, an offset signal is applied to the tracking error signal so as to change the tracking point, thereby correcting optically the shape of the light spot 32 on the recording surface of the magneto-optical recording medium 13. Therefore, generation of the off-axis aberration on the recording surface of the magneto-optical recording medium 13 can be suppressed by use of the optical head according to the third embodiment, and thus the increase of cross talk can be suppressed. In this manner, an optical head and disk recording/reproducing apparatus having higher performance can be realized according to the third embodiment.

Similar to the optical head of the first embodiment, the optical head of the third embodiment can have a temperature detector for detecting temperature around the optical head. In this case, the control portion can generate an offset signal on the basis of the detected ambient temperature and the off-track amount. This embodiment enables correction of an off-track generated due to the change in the shape of the light spot 32 and aberration caused by the temperature change, thereby improving remarkably the recording/reproducing performance.

### INDUSTRIAL APPLICABILITY

As mentioned above, the present invention is characterized in that it includes calculating a defocus amount or an off-track amount of a light spot generated in accordance with a shift amount in a radial direction of an objective lens, and applying an offset signal generated therefrom to either a focus error signal or a tracking error signal.

Thereby, according to the present invention, the shape of the light spot formed on a recording surface of a disc-shape recording medium can be corrected optically by changing a focus point or a tracking point.

Furthermore, since a servo position can be corrected electrically, it is possible to improve remarkably the degradation of a reproduction signal and a servo signal that are generated in accordance with the shift amount in the radial direction of the objective lens. Furthermore, the recording performance and the reproduction performance in the optical head and the disk recording/reproducing apparatus can be improved remarkably.

Furthermore, since the characteristics can decrease, in accordance with the shift amount of the objective lens, influences of the off-axis aberration generated on the recording surface of a disc-shape recording medium, the optical head and the disk recording/reproducing apparatus can be downsized and decreased in thickness.

1.-4. (CANCELED)

5. An optical head comprising: a light source, an objective lens for converging a light beam from the light source on a recording surface of a disc-shape recording medium, an objective lens drive portion for driving the objective lens in a radial direction and in a focus direction of the disc-shape recording medium by applying a drive current to a coil attached to the objective lens, a first light-receiving portion and a second light-receiving portion for receiving light reflected by the recording surface of the disc-shape recording medium and converting the reflected light into an electric signal, a signal generation portion for generating a focus error signal from the electric signal converted at the first light-receiving portion and generating a tracking error signal from the electric signal converted at the second light-receiving portion, and a control portion for controlling the objective lens drive portion, on the basis of the focus error signal and the tracking error signal; wherein
the control portion calculates a defocus amount corresponding to a level of the drive current applied by the objective lens drive portion so as to shift the objective lens in the radial direction, generates an offset signal based on the calculated defocus amount, and applies the generated offset signal to the focus error signal so as to control the objective lens drive portion.

6. The optical head according to claim 5, wherein the second light-receiving portion is composed of a plurality of light-receiving elements, and the control portion calculates the shift amount in the radial direction of the objective lens due to the objective lens drive portion on the basis of the electric signal obtained as a result that a part of the plural light-receiving elements converts the light beam reflected outside the interference region of the information track.

7. (CANCELED)

8. The optical head according to claim 5, wherein the control portion calculates a decentering amount with respect to a rotation center on the disc-shape recording medium and generates an offset signal on the basis of the calculated decentering amount and the calculated defocus amount.

9. The optical head according to claim 5, wherein a temperature detector for detecting an ambient temperature is provided, and the control portion generates an offset signal on the basis of the detected ambient temperature and the calculated defocus amount.

10. The optical head according to claim 5, wherein the control portion changes the calculated defocus amount so as to generate an offset signal, and a degree of changing the calculated offset amount differs between a time of recording and a time of reproduction.

11. The optical head according to claim 5, wherein the control portion changes the calculated defocus amount so as to generate an offset signal, and a degree of changing the calculated offset amount differs depending on the type of the disc-shape recording medium specified by at least one of a reflectance, a track density, a disk thickness, a disk diameter, a recording method and a shape of track groove.

12. An optical head comprising: a light source, an objective lens for converging a light beam from the light source on a recording surface of a disc-shape recording medium, an objective lens drive portion for driving the objective lens in a radial direction and in a focus direction of the disc-shape recording medium, a first light-receiving portion and a second light-receiving portion for receiving light reflected by the recording surface of the disc-shape recording medium and converting the reflected light into electric signals, a signal generation portion for generating a focus error signal from the electric signal converted at the first light-receiving portion and generating a tracking error signal from the electric signal converted at the second light-receiving portion, and a control portion for controlling the objective lens drive portion based on the focus error signal and the tracking error signal; wherein
the control portion calculates an off-track amount corresponding to the shift amount in the radial direction of the objective lens due to the objective lens drive portion, generates an offset signal based on the calculated off-track amount, and applies the generated offset signal to the tracking error signal so as to control the objective lens drive portion.

13. A disk recording/reproducing apparatus comprising at least the optical head according to claim and a feeder for feeding the optical head in the radial direction of the disc-shape recording medium, wherein
the feeder comprises at least a feed screw that fits the optical head so as to shift the optical head in the radial direction and a drive motor for rotating the feed screw, and the feeder is configured so that the drive motor rotates to feed the optical head when the shift in the radial direction of the objective lens due to the objective lens drive portion exceeds a certain value, and
the feed amount of the optical head due to the feeder differs between a time of recording and a time of reproduction.

14. (CANCELED)

15. (CANCELED)

16. A disk recording/reproducing apparatus comprising at least the optical head according to claim 12, and a feeder for feeding the optical head in the radial direction of the disc-shape recording medium, wherein
the feeder comprises at least a feed screw that fits the optical head so as to shift the optical head in the radial direction and a drive motor for rotating the feed screw, and the feeder is configured so that the drive motor rotates to feed the optical head when the shift in the radial direction of the objective lens due to the objective lens drive portion exceeds a certain value, and
the feed amount of the optical head due to the feeder differs between a time of recording and a time of reproduction.
